(19) United States
(12) Patent Application Publication
(10) Pub. No.: US 2023/0052538 A1
(43) Pub. Date: Feb. 16, 2023

(54) SYSTEMS AND METHODS FOR DETERMINING TOKEN RATES WITHIN A RATE-DISTORTION OPTIMIZATION HARDWARE PIPELINE

(71) Applicant: Meta Platforms, Inc., Menlo Park, CA (US)

(72) Inventors: Zhao Wang, Newark, CA (US); Srikanth Alaparthi, Fremont, CA (US); Yunqing Chen, Los Altos, CA (US); Baheerathan Anandharengan, Milpitas, CA (US); Gaurang Chaudhari, Sunnyvale, CA (US); Junqiang Lan, Fremont, CA (US); Harikrishna Madadi Reddy, San Jose, CA (US); Prahlad Rao Venkatapuram, Saratoga, CA (US)

(21) Appl. No.: 17/588,044

(22) Filed: Jan. 28, 2022

Related U.S. Application Data
(60) Provisional application No. 63/232,941, filed on Aug. 13, 2021.

(51) Int. Cl. H04N 19/625; H04N 19/122; H04N 19/423; H04N 19/147

(52) U.S. Cl. CPC H04N 19/625; H04N 19/122; H04N 19/423; H04N 19/147

(57) ABSTRACT

A disclosed method may include storing, within a hardware memory device included as part of a rate—distortion optimization (RDO) hardware pipeline, at least one transform unit table that (1) is pregenerated from a seed probability table for transformation of video data in accordance with a video encoding standard, (2) corresponds to a transform operation supported by the video encoding standard, and (3) corresponds to a transform unit included in the RDO hardware pipeline. The method may also include determining, by accessing the transform unit table, an RDO token rate for an encoding of the video data by a hardware video encoding pipeline that includes the RDO hardware pipeline, and selecting, based on the RDO token rate, a transform operation for the encoding of the video data.

### CROSS REFERENCE TO RELATED APPLICATION

This application claims the benefit of U.S. Provisional Patent Application 63/232,941, filed Aug. 13, 2021, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an example system for determining token rates within a rate—distortion optimization (RDO) hardware pipeline in accordance with some embodiments described herein.

FIG. 2 is a block diagram of an example implementation of a system for determining token rates within a RDO hardware pipeline in accordance with some embodiments described herein.

FIG. 3 is a flow diagram of an example method for determining token rates within a RDO hardware pipeline as described herein.

FIG. 4 is a block diagram that illustrates generation of transform tables from a seed probability table as described herein.

FIG. 5 is a block diagram that illustrates transform tables associated with transform operations that may be included as part of one or more hardware pipelines as described herein.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

Modern video encoding standards, such as VP9, are generally based on hybrid coding frameworks that may compress video data by exploiting redundancies within the video data. Compression may be achieved by identifying and storing only differences within the video data, such as may occur between temporally proximate frames (i.e., inter-frame coding) and/or between spatially proximate pixels (i.e., intra-frame coding). Inter-frame compression uses data from one or more earlier or later frames in a sequence to describe a current frame. Intra-frame coding, on the other hand, uses only data from within the current frame to describe the current frame.

Modern video encoding standards may additionally employ compression techniques like quantization that may exploit perceptual features of human vision, such as by eliminating, reducing, and/or more heavily compressing aspects of source video data that may be less relevant to human visual perception than other aspects. For example, as human vision may generally be more sensitive to changes in brightness than changes in color, a video encoder using a particular video codec may use more data to encode changes in luminance than changes in color. In all, video encoders must balance various trade-offs between video quality, bit rate, processing costs, and/or available system resources to effectively encode and/or decode video data.

Conventional or traditional methods of making encoding decisions may involve simply choosing a result that yields the highest quality output image according to some quality standard. However, such methods may choose settings that may require more bits to encode video data while providing comparatively little quality benefit. As an example, during a motion estimation portion of an encoding process, adding extra precision to representation of motion vectors of blocks might increase quality of an encoded output video, but the increase in quality might not be worth the extra bits necessary to encode the motion vectors with a higher precision.

As an additional example, during a basic encoding process, an encoder may divide each frame of video data into processing units. Depending on the codec, these processing units may be referred to as macroblocks (MB), coding units (CU) and/or coding tree units (CTU). Modern codecs may select a particular mode (i.e., a processing unit size and/or shape) from among several available modes for encoding video data. This mode decision may greatly impact an overall rate—distortion result for a particular output video file.

In order to determine or decide an optimal bit rate having an acceptable level of distortion, some modern codecs may use a technique called Lagrangian rate—distortion optimization. Rate—distortion optimization, also referred to as rate distortion optimized mode selection, or simply RDO, is a technique for choosing a coding mode of a macroblock based on a bitrate cost and distortion cost. In one expression, the bitrate cost R and distortion cost D may be combined into a single cost J:

J=D+λR (1)

An RDO mode selection algorithm may attempt to find a mode that may optimize (e.g., minimize) the joint cost J. A trade-off between R and D may be controlled by Lagrange multiplier λ. A smaller λ may emphasize minimizing D, allowing a higher bitrate, where a larger, may tend to minimize R at with an expense of a higher distortion. Selecting an optimum λ for a particular sequence may be a computationally intense problem. In some examples, empirical approximations may provide an effective choice of A in a practical mode selection scenario. In some examples, A may be calculated as a function of a quantization parameter (QP).

Distortion (D) may be calculated as the Sum of Squared Distortion (SSD) in accordance with

$${D}_{SSD} = {\sum }_{x , y} {( b ( x , y ) - {b}^{′ ( x , y )} )}^{2} \qquad ( 2 )$$

where x, y are sample positions within a block, b(x, y) are original sample values, and b′(x, y) are decoded sample salutes at each sample position. This is merely an example, however, as other distortion metrics, such as Sum of Absolute Differences (SAD) or Sum of Absolute Transformed Differences (SATD) may be used in these or related distortion calculations.

An RDO mode selection algorithm may involve, for every macroblock and for every available coding mode m, coding the macroblock using m and calculating R as a number of bits required to code the macroblock. The macroblock may be reconstructed and D, the distortion between the original and decoded macroblocks, may be determined. The mode cost Jₘ may then be calculated, with a suitable choice of A. The mode that gives the minimum Jₘ may then be identified and selected.

Clearly, the above is a computationally intensive process, as there may be hundreds of possible mode combinations. It may be necessary to code and decode a macroblock hundreds of times to find a “best” mode for optimizing rate versus distortion. Some systems may attempt to offload some of this high computational burden to specialized hardware. Unfortunately, different video codecs may support different modes and/or may employ different techniques for analyzing and/or encoding video data. Consequently, there may be a high cost of redundancy in such specialized RDO hardware, particularly when that specialized hardware may need to support multiple codecs. This redundancy may result in hardware complexity and high power usage. Furthermore, conventional systems and methods for determining possible token rates (i.e., rates at which video data may be encoded via a particular transform operation) for RDO may be similarly inefficient or require multiple computational steps. Hence, the instant application identifies and addresses a need for improved systems and methods for determining token rates within a RDO hardware pipeline.

The present disclosure is generally directed to systems and methods for determining token rates within a RDO hardware pipeline. As will be explained in greater detail below, embodiments of the instant disclosure may store, within a hardware memory device included as part of a RDO hardware pipeline, at least one transform unit table. The transform unit table may be pregenerated from a seed probability table for transformation of video data in accordance with a video encoding standard (e.g., VP9, H.264, H.265, etc.). The transform unit table may correspond to a transform operation supported by the video encoding standard, and may correspond to a transform unit, included in the RDO hardware pipeline, that may be configured to execute at least part of the transform operation in hardware.

By accessing the pregenerated transform unit table, an embodiment may determine an RDO token rate for an encoding of the video data by a hardware video encoding pipeline that includes the RDO hardware pipeline. Based on the determined RDO token rate, the embodiment may select a transform operation for the encoding of the video data (e.g., a transform operation that meets a suitable rate—distortion metric).

Among other benefits, by using pregenerated transform unit tables to determine an RDO token rate as part of an RDO operation rather than by determining the token rate based on the seed probability table during the encoding process, embodiments of the systems and methods described herein may reduce overall power consumption of the RDO hardware pipeline, and hence may realize significant power savings over conventional or traditional video encoding processes and/or systems.

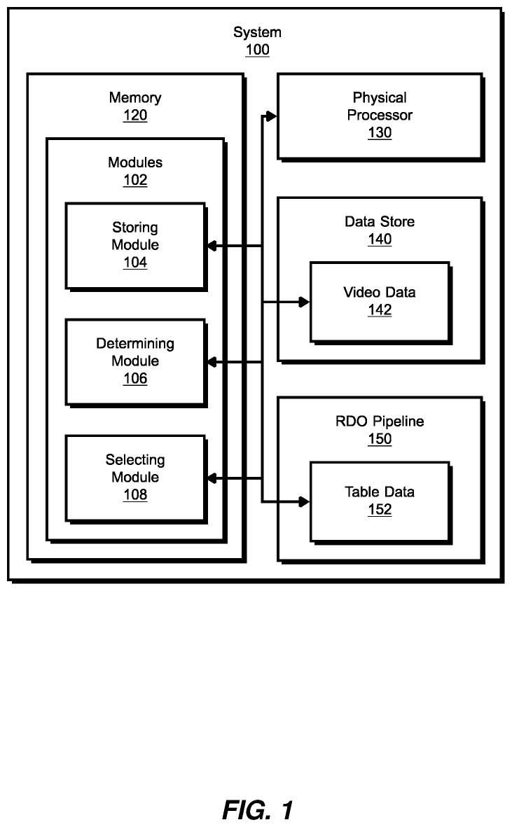

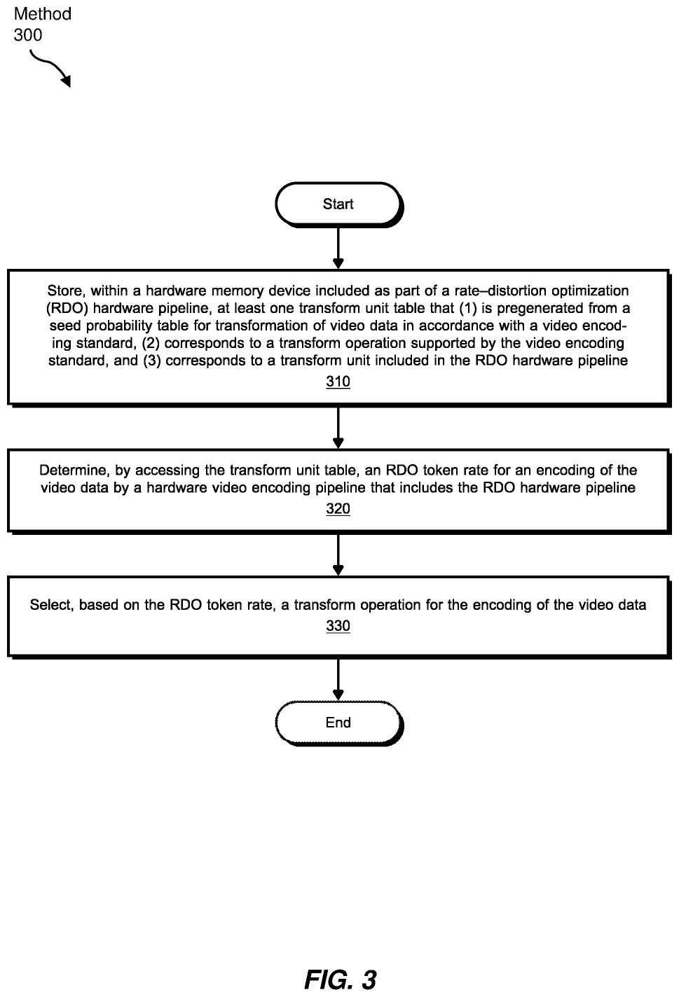

The following will provide, with reference to FIGS. 1-2 and 4-5, detailed descriptions of systems for determining token rates within a RDO hardware pipeline. Detailed descriptions of corresponding computer-implemented methods will also be provided in connection with FIG. 3.

FIG. 1 is a block diagram of an example system 100 for determining token rates within a RDO hardware pipeline. As illustrated in this figure, example system 100 may include one or more modules 102 for performing one or more tasks. As will be explained in greater detail below, modules 102 may include a storing module 104 that may store, within a hardware memory device included as part of a rate—distortion optimization (RDO) hardware pipeline, at least one transform unit table. Example system 100 may additionally include a determining module 106 that determines, by accessing the transform unit table, an RDO token rate for an encoding of the video data by a hardware video encoding pipeline that includes the RDO hardware pipeline. Additionally, example system 100 may also include a selecting module 108 that selects, based on the RDO token rate, a transform operation for the encoding of the video data.

As further illustrated in FIG. 1, example system 100 may also include one or more memory devices, such as memory 120. Memory 120 generally represents any type or form of volatile or non-volatile storage device or medium capable of storing data and/or computer-readable instructions. In one example, memory 120 may store, load, and/or maintain one or more of modules 102. Examples of memory 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As further illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 120. Additionally or alternatively, physical processor 130 may execute one or more of modules 102 to facilitate determining token rates within a RDO hardware pipeline. Examples of physical processor 130 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As also shown in FIG. 1, example system 100 may further include one or more data stores, such as data store 140, that may receive, store, and/or maintain video data 142. Data store 140 may represent portions of a single data store or computing device or a plurality of datastores or computing devices. In some embodiments, data store 140 may be a logical container for data and may be implemented in various forms (e.g., a database, a file, a file system, a data structure, etc.). Examples of data store 140 may include, without limitation, files, file systems, data stores, databases, and/or database management systems such as an operational datastore (ODS), a relational database, a No SQL database, a NewSQL database, and/or any other suitable organized collection of data.

In at least one example, data store 140 may include (e.g., store, host, access, maintain, etc.) video data 142. As will be explained in greater detail below, in some examples, video data 142 may include and/or represent any data that may be encoded via a video encoding process, such as scene data, frame data, image data, and/or any other suitable form of visual data, audio data, and/or audiovisual data.

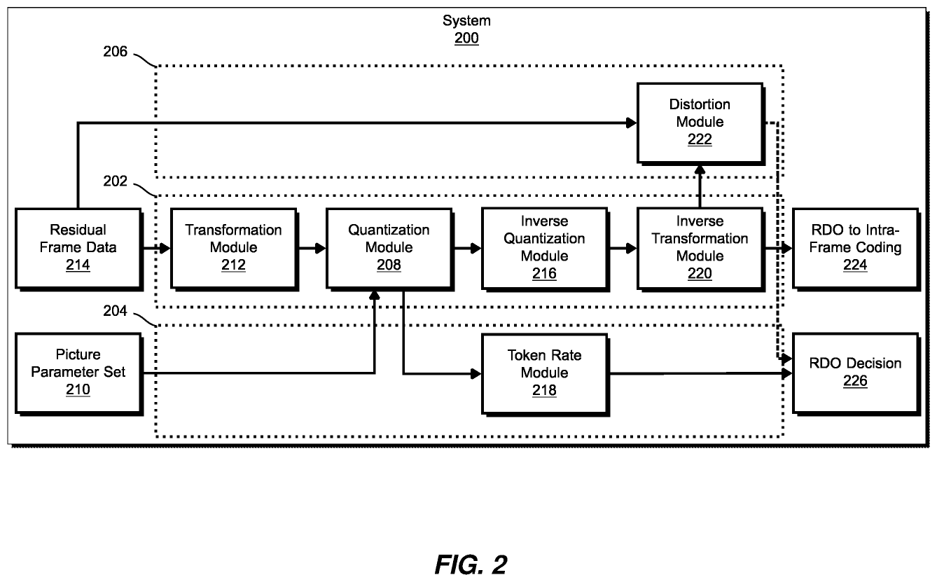

Also shown in FIG. 1, example system 100 may include an RDO pipeline 150 that may store, cache, and/or maintain table data 152. As will be explained in greater detail below in reference to FIG. 2, RDO pipeline 150 may include a hardware pipeline for performing one or more portions of a rate—distortion optimization operation. Table data 152 may include any portion of a transform table, which may include any set of data that may be accessed to determine a token rate for video data encoded using a particular transform operation given a particular set of quantization parameters.

Table data 152 may be pregenerated from a seed probability table in accordance with a video encoding standard. For example, a VP9 video encoding standard may specify a seed probability table that may be used to identify a transform table that may include a suitable token rate. The systems and methods described herein may store (e.g., within a suitable memory device, such as memory 120 and/or a memory device included as part of the RDO hardware pipeline) a pregenerated transform table and may access the pregenerated transform table during one or more operations of the RDO hardware pipeline.

Example system 100 in FIG. 1 may be implemented in a variety of ways. For example, all or a portion of example system 100 may represent portions of an example system 200 (“system 200”) in FIG. 2. Example system 200 includes a hardware pipeline for RDO in accordance with some embodiments described herein. In at least one example, one or more components included in system 200 may implement hardware and/or software that may perform and/or execute one or more functions of one or more of modules 102.

As illustrated in FIG. 2, example system 200 may include a hardware distortion data pipeline 202, a hardware determination pipeline 204, and a hardware token rate pipeline 206. Each of these parallel pipelines may include various modules that may perform various functions within in an RDO workflow.

As further shown in FIG. 2, hardware distortion data pipeline 202 may include a quantization module 208 that may generate a quantized data set based on a picture parameter set 210 and a transformed data set, such as a transformed data set received from transformation module 212.

In some examples, a picture parameter set (PPS) (e.g., PPS 210) may include a syntax and/or data structure that may contain syntax and/or data elements that may apply to an entire coded picture. In some examples, a PPS may be included within one or more network abstraction layer (NAL) units. A PPS NAL unit may include and/or contain parameters that may apply to the decoding of one or more individual pictures inside a coded video sequence. The possible contents and/or syntax of a PPS may be defined within a suitable video encoding standard (e.g., H.264/AVC, HEVC, VP9, etc.). Furthermore, in some examples, a PPS may include one or more quantization parameters (QP) for quantization of transformed residual data.

As will be described in greater detail below, the transformed data set (also referred to herein as “TX”) may include a residual frame data set (e.g., residual frame data 214) that has been transformed by transformation module in accordance with a transformation operation supported by a suitable video encoding process (e.g., H.264/AVC, VP9, etc.). In some examples, residual frame data 214 may include or represent a DCT difference between an input frame (e.g., a frame, a block, a macroblock, etc.) and an intra- or inter-predicted frame (e.g., a frame, a block, a macroblock, etc.).

In a quantization operation, less complex (e.g., integer) values may be selected to represent this DCT difference. These less complex quantized values may be more readily compressed than the computed DCT difference. A quantization process or operation may be mathematically expressed as:

$$C [ x ] = sign ( x ) \times max ( 0 , floor ( \frac{\vert x \vert}{s} + 1 - z ) ) \qquad ( 3 )$$

where x may represent an initial transformed residual value, C[x] may denote a quantized residual value, s may represent a quantization step (QStep) and z may represent rounding parameters. As human vision may not be sensitive to high-frequency components of a frame, according to the position of each transformed data, a quantizing process may apply a large quantization step s to such high-frequency components to reduce an overall bitrate of the encoded video stream.

Hence, quantization module 208 may generate, based on PPS 210 and a TX data set received from transformation module 212, a quantized (Q) data set. As shown in FIG. 1, this Q data set may be received by an inverse quantization module 216 within hardware distortion data pipeline 202 and a token rate module 218 that may be included as part of hardware token rate pipeline 206. Inverse quantization module 216 may generate an inversely quantized (IQ) data set by executing an inverse quantization of the Q data set, and inverse transformation module 220 may generate an inversely transformed (ITX) data set by executing an inverse transformation of the IQ data set. Distortion module 222, included as part of hardware determination pipeline 204, may then receive the ITX data set and determine a distortion metric based on the ITX data set and residual frame data 214. Likewise, the ITX data set may be passed from the RDO workflow to an intra-frame coding workflow at module 224.

Distortion module 222 may determine a distortion metric based on the ITX data set and the residual frame data set in any suitable way, using any suitable distortion metric that may measure a degree of deviation of the ITX data set from residual frame data 214. For example, distortion module 222 may determine a mean squared error (MSE) between the ITX data set and residual frame data 214. As other examples, distortion module 222 may determine a SSD, SAD, SATD, or other distortion metric. This determined distortion metric may be used by RDO decision module 226 to determine whether to adjust an encoding rate to optimize and/or reduce an amount of distortion in an encoded video stream or file.

As noted above, token rate pipeline 206 may determine, via token rate module 218 and based on a Q data set (e.g., quantized data received from quantization module 208), a token rate for an encoding of residual frame data 214 via a video encoding pipeline (e.g., a video encoding pipeline that may include system 200). Token rate module 218 may determine the token rate in any suitable way. For example, as further noted above, a rate and/or a suitable A value may be calculated as a function of a (QP), and various emperical approximations may be used to select A and/or determine a rate R based on a provided QP.

Token rate module 218 may determine a suitable token rate in different ways for different video encoding standards. For example, for an H.264/AVC video encoding standard, the token rate may be calculated via a series of look-up table checking. In conventional H.264 implementations, an encoder may access a single look-up table to find a suitable value for token rate calculation. In conventional VP9 implementations, an encoder may use multiple levels of look-up tables generated from an initial seed probability table.

However, in the present system, token rate module 218 may access and/or reference different pre-populated look-up tables depending on a size and/or type of transform unit (TU) sub block under consideration. As an illustration, for VP9, an intra4×4 block, inter4×4 block, intra8×8 block, and inter8×8 block may each use a different look-up table. These look-up tables may be pre-processed and stored within a suitable storage medium accessible to token rate module 218. In this way, token rate module 218 may access and/or reference a much smaller look-up table for each token rate calculation, which may tremendously reduce computing resources and/or conserve electrical resources.

FIG. 3 is a flow diagram of an example computer-implemented method 300 for determining token rates within a RDO hardware pipeline as described herein. The steps shown in FIG. 3 may be performed by any suitable computer-executable code, computing hardware, and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which are provided herein.

As illustrated in FIG. 3, at step 310, one or more of the systems described herein may store, within a hardware memory device included as part of a RDO hardware pipeline, at least one transform unit table. The transform unit table may (1) be pregenerated from a seed probability table for transformation of video data in accordance with a video encoding standard, (2) correspond to a transform operation supported by the video encoding standard, and (3) correspond to a transform unit included in the RDO hardware pipeline. For example, as described above, storing module 104 may cause one or more components included in system 200 (e.g., token rate module 218) to store, within a hardware memory device included as part of a RDO hardware pipeline (e.g., as part of or accessible to token rate module 218), at least one transform unit table.

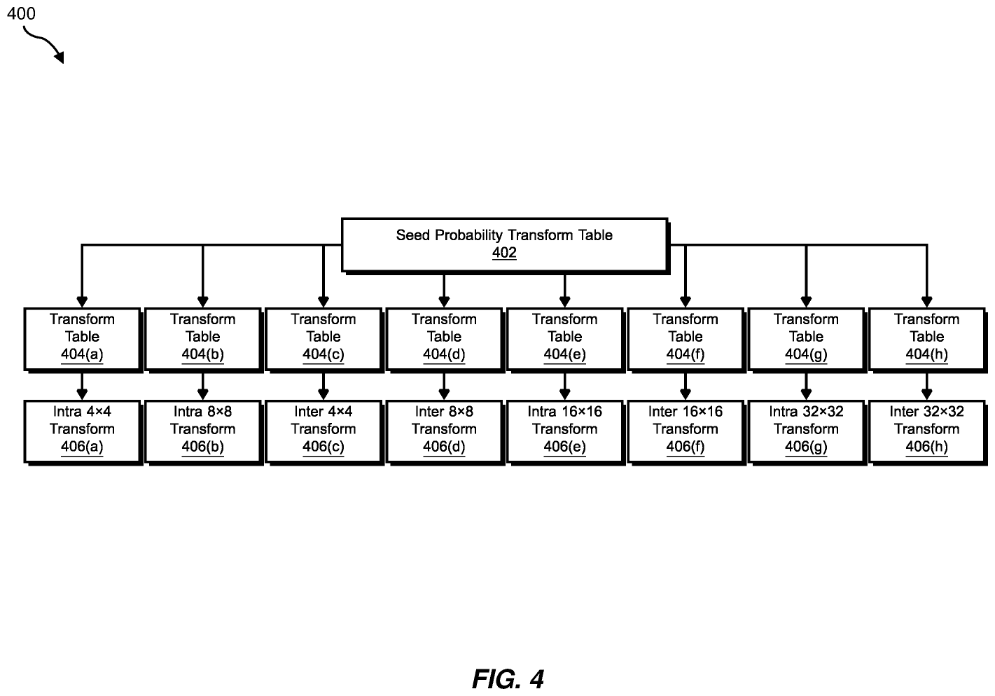

By way of illustration, FIG. 4 is a block diagram 400 that illustrates generation of transform tables from a seed probability table. As shown in FIG. 4, seed probability transform table 402 may include data that may enable an RDO system to identify a token rate for an RDO operation. As shown in FIG. 4, seed probability table 402 may be used to generate transform tables 404(a) through 404(h), each of which may be associated with a transform operation 406 (e.g., transform operation 406(a) through 406(h)) supported by a video encoding standard (e.g., VP9) and/or a transform unit included in an RDO hardware pipeline (e.g., as shown in FIG. 2). Each of transform tables 404 may be stored within a memory device included in and/or accessible to token rate module 218, and token rate module 218 may access at least one of transform tables 404 to determine a token rate associated with one or more transform operations 406.

FIG. 4 may also show various transform partition sizes and operations that may be included as part of one or more hardware pipelines as described herein. As shown, a transformation module (e.g., transformation module 212) may support, for inter-prediction and/or intra-prediction via an H.264/AVC video encoding standard and/or a VP9 video encoding standard, various partition sizes and/or discrete cosine transform block sizes. Furthermore, in some examples, a transformation module may support, for intra-prediction via a VP9 video encoding standard, discrete sine transforms having various block sizes.

Returning to FIG. 3, at step 320, one or more of the systems described herein may determine, by accessing the transform unit table, an RDO token rate for an encoding of the video data by a hardware video encoding pipeline that includes the RDO hardware pipeline. For example, determining module 106 may cause one or more components included in system 200 (e.g., token rate module 218) to determine, by accessing the transform unit table, an RDO token rate for an encoding of the video data by a hardware video encoding pipeline that includes the RDO hardware pipeline.

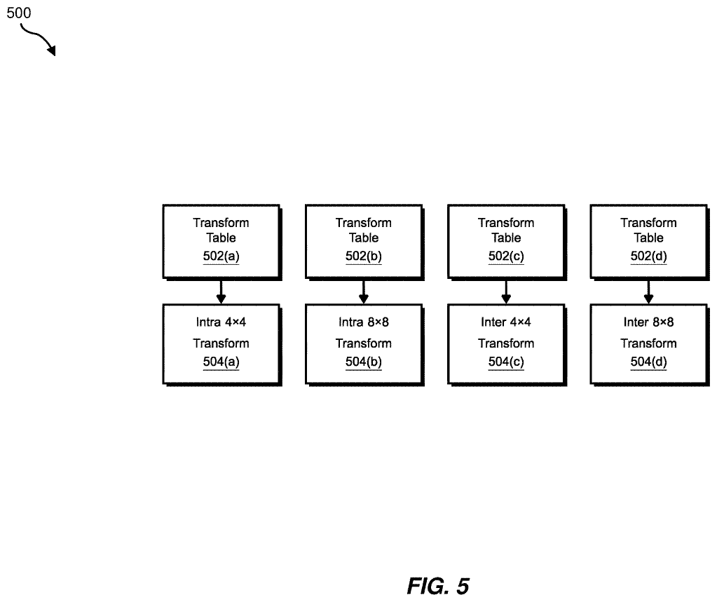

As a further illustration, FIG. 5 is a block diagram 500 that illustrates transform tables associated with transform operations that may be included as part of one or more hardware pipelines as described herein. Each of transform tables 502 (e.g., transform table 502(a) through 502(d)) may be associated with a different transform operation 504 (e.g., transform operations 504(a) through 504(b)), and may be stored within a memory device accessible to token rate module 218. During an encoding of video data (e.g., video data 142), token rate module 218 may access a transform table 502 to determine a token rate associated with a transform operation 504. For example, if the transform operation is a four pixel by four pixel intra transform, token rate module 218 may determine an RDO token rate for the encoding by accessing transform table 502(a), which is associated with transform operation 504(a) (i.e., intra transform having a block size of 4×4).

Returning to FIG. 3, at step 330, one or more of the systems described herein may select, based on the RDO token rate, a transform operation for the encoding of the video data. For example, selecting module 108 may cause one or more components included in system 200 (e.g., RDO decision module 226) to select a transform operation for the encoding of the video data based on the RDO token rate. As described above in reference to FIG. 2, RDO decision module 226 may determine whether to adjust an encoding rate to optimize and/or reduce an amount of distortion in an encoded video stream or file. Hence, if a token rate determined by token rate module 218 corresponds to a transform operation that, when used to encode the video data at the RDO token rate, meets a predetermined rate—distortion metric, selecting module 108 may cause RDO decision module 226 to select the transform operation to encode the video data.

As discussed throughout the instant disclosure, the disclosed systems and methods may provide one or more advantages over traditional options for RDO. In conventional software implementations of RDO, an RDO token rate may be calculated by a series of look up table checking. In software implementations of VP9, an initial seed probability table is read and the results mapped to a much larger intermediate mapped probability table. The bigger table may then be fed into each transform unit partition for a final token rate calculation.

Conversely, embodiments of the systems and methods described herein may pre-read in the seed probability table and then pre-generate multiple (e.g., 8) different, potentially much smaller tables, each mapped to a different transform unit. Embodiments may then store the generated transform tables internally (e.g., within the hardware pipeline). Then, during encoding, each transform unit may only need to access a much smaller lookup table (e.g., one or more of transform tables 404 and/or transform tables 502). This may tremendously reduce the hardware resources required for RDO and/or may greatly conserve electrical resources over conventional and/or software based RDO solutions. In some examples, embodiments of the systems and methods described herein may result in up to 30 times (e.g., up to 30×) reduction in power consumption over conventional or traditional RDO solutions.

### EXAMPLE EMBODIMENTS

Example 1: A method comprising (1) storing, within a hardware memory device included as part of a rate—distortion optimization (RDO) hardware pipeline, at least one transform unit table that (a) is pregenerated from a seed probability table for transformation of video data in accordance with a video encoding standard, (b) corresponds to a transform operation supported by the video encoding standard, and (c) corresponds to a transform unit included in the RDO hardware pipeline, (2) determining, by accessing the transform unit table, an RDO token rate for an encoding of the video data by a hardware video encoding pipeline that includes the RDO hardware pipeline; and (3) selecting, based on the RDO token rate, a transform operation for the encoding of the video data.

Example 2: The computer-implemented method of example 1, wherein selecting the transform operation comprises selecting, from a plurality of transform operations supported by the video encoding standard, a transform operation that, when used to encode the video data at the RDO token rate, meets a predetermined threshold of a rate—distortion metric.

Example 3: The computer-implemented method of any of examples 1 and 2, further comprising encoding, via the hardware video encoding pipeline, the video data in accordance with the video encoding standard using the selected transform operation.

Example 4: The computer-implemented method of any of examples 1-3, wherein the transform unit is included in a plurality of transform units included in the RDO hardware pipeline, each transform unit in the plurality of transform units corresponding to a different transform operation supported by the video encoding standard.

Example 5: The computer-implemented method of any of examples 1-4, wherein the transform unit table is included in a plurality of transform unit tables stored within the hardware memory device, each transform unit table in the plurality of transform unit tables corresponding to a different transform operation supported by the video encoding standard.

Example 6: The computer-implemented method of any of examples 15, wherein the video encoding standard comprises a VP9 video encoding standard.

Example 7: The computer-implemented method of example 6, wherein the transform operation supported by the video encoding standard comprises at least one of (1) a discrete cosine transform having dimensions of up to thirty-two pixels by thirty-two pixels, or (2) a discrete sine transform having dimensions of up to thirty-two pixels by thirty-two pixels.

Example 8: The computer-implemented method of example 7, wherein the transform operation supported by the video encoding standard comprises at least one of (1) a discrete cosine transform having dimensions of four pixels by four pixels, (2) a discrete cosine transform having dimensions of eight pixels by eight pixels, (3) a discrete cosine transform having dimensions of sixteen pixels by sixteen pixels, or (4) a discrete cosine transform having dimensions of thirty-two pixels by thirty-two pixels.

Example 9: The computer-implemented method of example 8, wherein the transform operation supported by the video encoding standard comprises at least one of (1) a discrete sine transform having dimensions of four pixels by four pixels, (2) a discrete sine transform having dimensions of eight pixels by eight pixels, (3) a discrete sine transform having dimensions of sixteen pixels by sixteen pixels, or (4) a discrete sine transform having dimensions of thirty-two pixels by thirty-two pixels.

Example 10: The computer-implemented method of any of examples 1-9, further comprising generating the transform unit table from the seed probability table.

Example 11: The computer-implemented method of any of examples 1-10, further comprising generating, from the seed probability table, a plurality of transform unit tables that includes the transform unit table, each transform unit table included in the plurality of transform unit tables corresponding to a different transform operation supported by the RDO hardware pipeline.

Example 12: A system comprising (1) a storing module, stored in memory, that stores, within a hardware memory device included as part of a rate—distortion optimization (RDO) hardware pipeline, at least one transform unit table that: (a) is pregenerated from a seed probability table for transformation of video data in accordance with a video encoding standard, (b) corresponds to a transform operation supported by the video encoding standard, and (c) corresponds to a transform unit included in the RDO hardware pipeline, (2) a determining module, stored in memory, that determines, by accessing the transform unit table, an RDO token rate for an encoding of the video data by a hardware video encoding pipeline that includes the RDO hardware pipeline, (3) a selecting module, stored in memory, that selects, based on the RDO token rate, a transform operation for the encoding of the video data, and (4) at least one physical processor that executes the storing module, the determining module, and the selecting module.

Example 13: The system of example 12, wherein the selecting module selects the transform operation by selecting, from a plurality of transform operations supported by the video encoding standard, a transform operation that, when used to encode the video data at the RDO token rate, meets a predetermined threshold of a rate—distortion metric.

Example 14: The system of any of examples 12 and 13, wherein the selecting module further encodes, via the hardware video encoding pipeline, the video data in accordance with the video encoding standard using the selected transform operation.

Example 15: The system of any of example 12-14, wherein the transform unit is included in a plurality of transform units included in the RDO hardware pipeline, each transform unit in the plurality of transform units corresponding to a different transform operation supported by the video encoding standard.

Example 16: The system of any of examples 12-15, wherein the transform unit table is included in a plurality of transform unit tables stored within the hardware memory device, each transform unit table in the plurality of transform unit tables corresponding to a different transform operation supported by the video encoding standard.

Example 17: The system of example 16, wherein the transform operation supported by the video encoding standard comprises at least one of (1) a discrete cosine transform having dimensions of up to thirty-two pixels by thirty-two pixels, or (2) a discrete sine transform having dimensions of up to thirty-two pixels by thirty-two pixels.

Example 18: The system of any of examples 12-17, wherein the storing module further generates the transform unit table from the seed probability table.

Example 19: The system of any of examples 12-18, wherein the storing module further generates, from the seed probability table, a plurality of transform unit tables that includes the transform unit table, each transform unit table included in the plurality of transform unit tables corresponding to a different transform operation supported by the RDO hardware pipeline.

Example 20: A non-transitory computer-readable medium comprising computer-readable instructions that, when executed by at least one processor of a computing system, cause the computing system to (1) store, within a hardware memory device included as part of a rate—distortion optimization (RDO) hardware pipeline, at least one transform unit table that (a) is pregenerated from a seed probability table for transformation of video data in accordance with a video encoding standard, (b) corresponds to a transform operation supported by the video encoding standard, and (c) corresponds to a transform unit included in the RDO hardware pipeline, (2) determine, by accessing the transform unit table, an RDO token rate for an encoding of the video data by a hardware video encoding pipeline that includes the RDO hardware pipeline, and (3) select, based on the RDO token rate, a transform operation for the encoding of the video data.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may video data to be transformed, transform the video data, output a result of the transformation to perform an RDO function, use the result of the transformation to compress video data, and store the result of the transformation to compress additional video data. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “processor” or “physical processor,” as used herein, generally refers to or represents any type or form of hardware-implemented processing unit capable of interpreting and/or executing computer-readable instructions. In one example, a physical processor may access and/or modify one or more of the modules described herein. Additionally or alternatively, a physical processor may execute one or more of the modules described herein to facilitate one or more RDO processes. Examples of a physical processor include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The term “memory,” as used herein, generally refers to or represents any type or form of volatile or non-volatile storage device or medium capable of storing data and/or computer-readable instructions. In one example, memory 120 may store, load, and/or maintain one or more of modules 102. Examples of memory 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A method comprising:
storing, within a hardware memory device included as part of a rate-distortion optimization (RDO) hardware pipeline, a plurality of different transform unit tables, wherein each transform unit table:
is pregenerated from a seed probability table for transformation of video data in accordance with a video encoding standard;
corresponds to a different transform operation supported by the video encoding standard; and
corresponds to a different transform unit included in the RDO hardware pipeline;
determining, by accessing at least one of the plurality of different transform unit tables, an RDO token rate for an encoding of the video data by a hardware video encoding pipeline that includes the RDO hardware pipeline; and
selecting, based on the RDO token rate, a transform operation for the encoding of the video data.

2. The computer-implemented method of claim 1, wherein selecting the transform operation comprises selecting, from a plurality of transform operations supported by the video encoding standard, a transform operation that, when used to encode the video data at the RDO token rate, meets a predetermined threshold of a rate-distortion metric.

3. The computer-implemented method of claim 1, further comprising encoding, via the hardware video encoding pipeline, the video data in accordance with the video encoding standard using the selected transform operation.

4. The computer-implemented method of claim 1, wherein each different transform unit is included in a plurality of transform units included in the RDO hardware pipeline, each different transform unit in the plurality of transform units corresponding to a different transform operation supported by the video encoding standard.

5. The computer-implemented method of claim 1, wherein each transform unit table in the plurality of different transform unit tables corresponds to a different transform operation supported by the video encoding standard.

6. The computer-implemented method of claim 1, wherein the video encoding standard comprises a VP9 video encoding standard.

7. The computer-implemented method of claim 6, wherein each different transform operation supported by the video encoding standard comprises at least one of:
a discrete cosine transform having dimensions of up to thirty-two pixels by thirty-two pixels; or
a discrete sine transform having dimensions of up to thirty-two pixels by thirty-two pixels.

8. The computer-implemented method of claim 7, wherein each different transform operation supported by the video encoding standard comprises at least one of:
a discrete cosine transform having dimensions of four pixels by four pixels;
a discrete cosine transform having dimensions of eight pixels by eight pixels;
a discrete cosine transform having dimensions of sixteen pixels by sixteen pixels; or
a discrete cosine transform having dimensions of thirty-two pixels by thirty-two pixels.

9. The computer-implemented method of claim 8, wherein each different transform operation supported by the video encoding standard comprises at least one of:
a discrete sine transform having dimensions of four pixels by four pixels;
a discrete sine transform having dimensions of eight pixels by eight pixels;
a discrete sine transform having dimensions of sixteen pixels by sixteen pixels; or
a discrete sine transform having dimensions of thirty-two pixels by thirty-two pixels.

10. The computer-implemented method of claim 1, further comprising generating the plurality of different transform unit tables from the seed probability table.

11. The computer-implemented method of claim 1, further comprising generating, from the seed probability table, the plurality of different transform unit tables, each transform unit table included in the plurality of different transform unit tables corresponding to a different transform operation supported by the RDO hardware pipeline.

12. A system comprising:
a storing module, stored in memory, that stores, within a hardware memory device included as part of a rate-distortion optimization (RDO) hardware pipeline, a plurality of different transform unit tables, wherein each transform unit table:
is pregenerated from a seed probability table for transformation of video data in accordance with a video encoding standard;
corresponds to a different transform operation supported by the video encoding standard; and
corresponds to a different transform unit included in the RDO hardware pipeline;
a determining module, stored in memory, that determines, by accessing at least one of the plurality of different transform unit tables, an RDO token rate for an encoding of the video data by a hardware video encoding pipeline that includes the RDO hardware pipeline;
a selecting module, stored in memory, that selects, based on the RDO token rate, a transform operation for the encoding of the video data; and
at least one physical processor that executes the storing module, the determining module, and the selecting module.

13. The system of claim 12, wherein the selecting module selects the transform operation by selecting, from a plurality of transform operations supported by the video encoding standard, a transform operation that, when used to encode the video data at the RDO token rate, meets a predetermined threshold of a rate-distortion metric.

14. The system of claim 12, wherein the selecting module further encodes, via the hardware video encoding pipeline, the video data in accordance with the video encoding standard using the selected transform operation.

15. The system of claim 12, wherein each transform unit in the plurality of transform units corresponds to a different transform operation supported by the video encoding standard.

16. The system of claim 12, wherein each transform unit table in the plurality of transform unit tables corresponds to a different transform operation supported by the video encoding standard.

17. The computer-implemented method of claim 6, wherein each different transform operation supported by the video encoding standard comprises at least one of:
a discrete cosine transform having dimensions of up to thirty-two pixels by thirty-two pixels; or
a discrete sine transform having dimensions of up to thirty-two pixels by thirty-two pixels.

18. The system of claim 12, wherein the storing module further generates the plurality of different transform unit tables from the seed probability table.

19. The system of claim 12, wherein the storing module further generates, from the seed probability table, the plurality of different transform unit tables, each transform unit table included in the plurality of different transform unit tables corresponding to a different transform operation supported by the RDO hardware pipeline.

20. A non-transitory computer-readable medium comprising computer-readable instructions that, when executed by at least one processor of a computing system, cause the computing system to:
store, within a hardware memory device included as part of a rate-distortion optimization (RDO) hardware pipeline, a plurality of different transform unit tables, wherein each transform unit table:
is pregenerated from a seed probability table for transformation of video data in accordance with a video encoding standard;
corresponds to a different transform operation supported by the video encoding standard; and
corresponds to a different transform unit included in the RDO hardware pipeline;
determine, by accessing at least one of the plurality of different transform unit tables, an RDO token rate for an encoding of the video data by a hardware video encoding pipeline that includes the RDO hardware pipeline; and
select, based on the RDO token rate, a transform operation for the encoding of the video data.
